(19) United States
(12) Patent Application Publication
(10) Pub. No.: US 2008/0013237 A1
(43) Pub. Date: Jan. 17, 2008

(54) OVER VOLTAGE PROTECTION CIRCUIT FOR GFCI DEVICES

(76) Inventors: Benjamin Moadel, New York, NY (US); Gaetano Bonasia, Bronx, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/766,614

(22) Filed: Jun. 21, 2007

Related U.S. Application Data
(60) Provisional application No. 60/806,425, filed on Jun. 30, 2006.

(51) Int. Cl. H02H 3/20

(52) U.S. Cl. 361/91.5

(57) ABSTRACT

An over voltage protection device for a GFCI having a voltage divider network connected across the line terminals of the GFCI, and an over voltage detecting diode connected between the voltage divider network and a gate terminal of an SCR. The voltage divider and diode cause a signal to be fed to the gate terminal of the SCR to trip the GFCI when an over voltage condition exists at the line terminals. The voltage divider is adjustable, with the sensitivity of the over voltage protection varying in accordance with adjustment of the potential from the voltage divider. In an embodiment of the invention, the circuit includes an indicator, such as a photodiode, which indicates the occurrence of an over voltage condition. In addition, a blocking diode is connected between the gate terminal of the SCR and a triggering terminal of an integrated circuit of the GFCI where the over voltage detecting diode conducts current to the gate terminal when an over voltage condition occurs, and the blocking diode conducts current to the gate terminal of the SCR when a ground-fault condition occurs.

This application claims the benefit of priority pursuant to 35 U.S.C. 119(e) from a U.S. Provisional Application having Application No. 60/806,425 filed Jun. 30, 2006.

### FIELD OF THE INVENTION

This invention relates to generally ground-fault circuit interrupter devices and more particularly to over voltage protection circuits capable of being used with those devices.

### DESCRIPTION OF THE PRIOR ART

Electrical wiring devices generally have a line side, which is connectable to an electrical power supply, and a load side, which is connectable to one or more loads and at least one path between line and load sides. Ground Fault Circuit Interrupter (GFCI) devices are now widely used to detect a ground fault condition and interrupt power to various loads (e.g. appliances and branch circuits) by breaking a connection between the line side and the load side. A typical GFCI is described in commonly owned U.S. Pat. No. 6,246,558, the disclosure of which is incorporated herein in its entirety by reference. This GFCI device is effective to detect either a ground fault (an unintended path between a phase conductor and ground) or a ground-neutral fault (an unintended path between a neutral conductor and ground).

Although a conventional GFCI protects downstream devices (devices connected to the load side of the GFCI) and persons against ground faults, it is not currently intended to provide protection against excess voltage on the line side. There is a need for a circuit capable of being used with a GFCI which can provide protection for downstream devices and people for both over voltage and ground-fault conditions.

### SUMMARY OF THE INVENTION

The present invention addresses the above-described need by providing a circuit which, when connected to a GFCI, monitors the voltage on the line side of the GFCI and causes the GFCI to trip if an over voltage is present. In accordance with the preferred embodiment of the present invention, an over voltage protection device for a GFCI includes a voltage divider network connected across the output terminals of the rectifier supplying power to the GFCI electronics, and an over voltage detecting diode, connected between the voltage divider network and a gate terminal of a device (e.g. a SCR). The voltage divider and over voltage detecting diode cause a signal to be fed to the gate terminal of the SCR to trip the GFCI when an over voltage condition exists at the line terminals. The voltage divider is adjustable, with the sensitivity of the over voltage protection varying in accordance with adjustment of the potential from the voltage divider. In an embodiment of the invention, the circuit includes a photodiode which emits light by conducting current to indicate the occurrence of an over voltage condition (which is activated by an indication triggering diode). In addition a blocking diode is connected between the gate terminal of the SCR and a triggering terminal of an integrated circuit of the GFCI. The gate terminal of the SCR is also where the over voltage detecting diode conducts current to the gate terminal when an over voltage condition occurs. The blocking diode blocks the signal from the over voltage detecting diode from reaching the integrated circuit.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals:

FIG. 1 is a schematic diagram of a GFCI including an integrated circuit configured to trigger a SCR;

FIG. 2 is a block diagram of a GFCI with an over voltage protection circuit connected thereto;

FIG. 3 is a schematic diagram of an over voltage protection circuit for a GFCI; and

FIG. 4 is a schematic diagram of another embodiment of an over voltage protection circuit for a GFCI.

### DESCRIPTION OF THE PREFERRED EMBODIMENT(S)

Ground Fault Circuit Interrupters (GFCIs) are well known electrical devices in common use today. They are used to help protect against electrical shock due to ground faults. A GFCI is basically a differential current detector which interrupts the flow of current from the line to the load when 5 mA or more of unbalanced current is detected between the phase conductor and the neutral conductor of an AC electrical power line. The unbalanced current detected is assumed to be flowing, possibly through a human who accidentally touches the phase wire, to ground. The current which flows to ground rather than returning through the differential transformer via the neutral wire creates the current imbalance. It is here noted that a leakage to ground of 5 mA or more will trip the GFCI and interrupt the flow of current to the load.

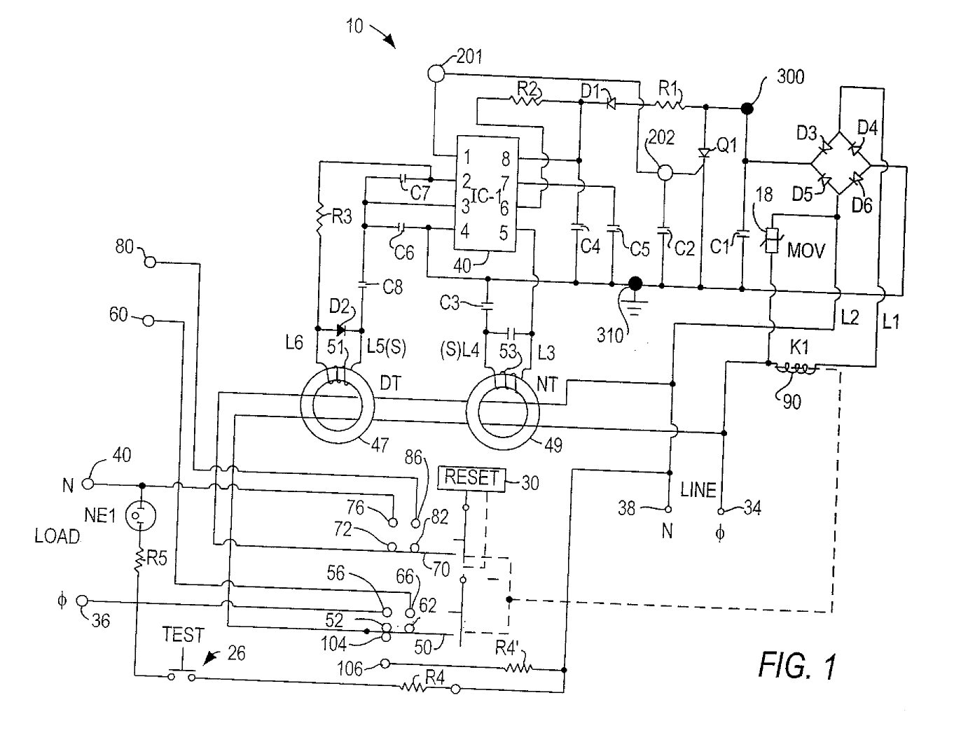

FIG. 1 is a schematic diagram of the ground fault circuit interrupter device. The GFCI, generally referenced 10, comprises two current transformers DT and NT consisting of magnetic cores 47, 49 and coils 51, 53, respectively, coupled to Integrated Circuit (IC) 40 which can comprise chip LM1851 manufactured by National Semiconductor or the RA9031 manufactured by Raytheon (although any suitable chip could be used). A solenoid coil 90 is placed between the line phase terminal 34 and one input to a full wave bridge rectifier. AC power from the phase 34 and neutral 38 terminals is full wave rectified via a full wave rectifier comprising diodes D3, D4, D5 and D6. A metal oxide varistor (MOV) 18 is placed across the phase and neutral for surge protection. The output of the rectifier is coupled across capacitor C1 and Silicon Controlled Rectifier (SCR) Q1. The output of the rectifier (which has a high side and a low side) powers the electronics of the GFCI. The gate of the SCR is coupled to a ground terminal 310 via capacitor C2 and to pin 1 of IC 40 through terminal 201.

A diode D2 is placed across coil 51 which is coupled across pins 2 and 3 via resistor R3 and capacitor C8. Pin 2 is coupled to capacitor C8 through capacitor C7 and pin 4 is coupled to capacitor C8 via capacitor C6, and directly to ground. Coil 53 is coupled to ground via capacitor C3 and directly to pin 5 of IC 40. A capacitor C9 is connected across coil 53. Pin 6 of IC 40 is coupled to pin 8 via resistor R2 and pin 7 is coupled to ground via capacitor C5. Pin 8 is also coupled to ground through capacitor C4 and through diode D1 and resistor R1 to the anode terminal of the SCR Q1 and to the junction of diodes D3, D5 of the diode bridge rectifier circuit. The voltage on pin 8 serves as the 26 V supply voltage for the GFCI circuitry.

Line side electrical conductors, phase and neutral, pass through the transformers DT and NT to the load side phase and neutral conductors. A circuit interrupted actuated by the solenoid, consisting of movable contacts 50, 70 associated with the phase and neutral conductors, respectively, function to open the circuit between line and load when a ground fault is detected. The movable contacts are part of the circuit interrupter including the solenoid which includes coil 90. The coil 90 of the solenoid is energized when a signal from pin 1 of the IC turns on the SCR, Q1. In addition, the GFCI 10 comprises a test circuit comprised of momentary push button switch 26 connected in series with resistor R4. When switch 26 is pressed, a temporary simulated ground fault, i.e., a temporary differential current path, from phase to neutral is created in order to test the operation of the GFCI 10.

The second differential transformer NT within the GFCI circuitry is provided to detect a low impedance condition between the load side neutral wire and ground. A low impedance neutral/ground connection allows ground fault current to leak back from the ground to the neutral wire passing through the differential transformers. This reduces the sensitivity of the GFCI and potentially permits lethal ground faults to occur without the GFCI tripping. If the impedance of the neutral/ground connection becomes too low, the IC 40 triggers the SCR Q1 via the signal from terminal 1 of the IC 40, thus disconnecting both phase and neutral from the load.

As described previously, the ground/neutral transformer NT is utilized to detect ground to neutral faults and is specifically designed for that purpose. For detecting ground faults, this transformer is used in a differential mode. The sum of the currents, in the two wires passing through its center, is zero in the absence of a ground fault or ground/neutral fault.

In particular, the GFCI circuit, generally referenced 10, comprises two current transformers consisting of magnetic cores 47, 49 and coils 51, 53, respectively, coupled to integrated circuit 40 which can comprise the integrated circuit chip LM 1851 manufactured by National Semiconductor or the RA9031 manufactured by Raytheon. The AC power from the phase and neutral conductors is full wave rectified via a full wave rectifier comprising diodes D3, D4, D5 and D6. A metal oxide varistor (MOV) 18 is placed across phase and neutral for protection. The voltage output of the rectifier is coupled across capacitor C1 and in series with diode D1. The cathode of the diode D1 is coupled to capacitor C4 and to ground. The gate of the SCR is coupled to receive the trigger signal from the IC 40. The output of pin 1 of IC 40 is the trigger input to the SCR Q1.

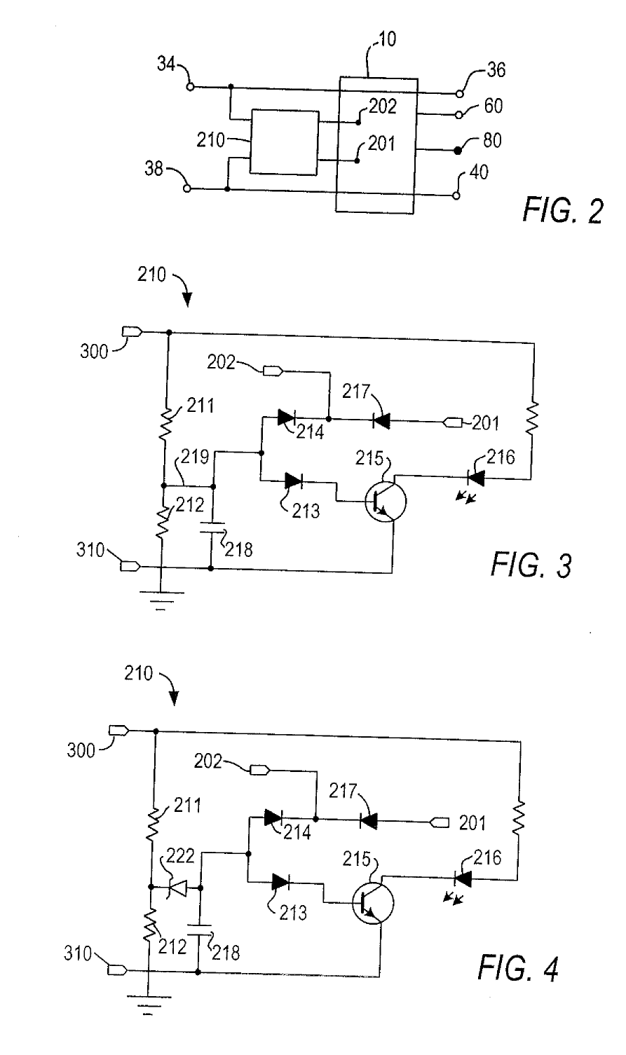

Referring to FIG. 2, there is shown a schematic illustration of the GFCI 10 with over voltage protection circuit 210 in accordance with the preferred embodiment of the invention connected thereto. It should be noted that the over voltage protection circuit 210 may be used with any type of GFCI and is not limited to the specific GFCI shown. GFCI 10 has external connections to line terminals 34, 38 (see also FIG. 1) and load terminals 36, 40, 60, and 80 for connection to various downstream devices, not shown. Circuit 210 has input terminals which are connected to the output of the rectifier; and circuit 210 also has output terminals connected to terminals 201 and 202 of the GFCI. Circuit 210 takes the place of the direct connection between terminals 201 and 202 in FIG. 1.

A schematic diagram of circuit 210 is shown in FIG. 3. Resistors 211 and 212 form a voltage divider network. The junction of resistors 211, 212 is connected via a direct connection conductive path 219, such as a wire conductor, to the anode terminals of diodes 213, 214 and through a capacitor 218 to a ground terminal. Typical resistance values for resistors 211 and 212 can be 200 k ohms, more or less, and 910 ohms, more or less, respectively. With these resistance values, an instantaneous forward voltage of approximately 0.0045V_{O}, where V_{O} is the rectifier voltage, appears at indication triggering diode 213 and over voltage detection diode 214.

An over voltage condition upstream of the GFCI on terminals 300, 310 will cause an over voltage on the output of the rectifier which will cause diodes 213, 214 to conduct forward current.

Forward current on over voltage detecting diode 214 will cause a trigger signal to be applied to terminal 202, then the SCR will conduct and the GFCI will trip. The cathodes of both over voltage indicating diode 214 and blocking diode 217 are connected to terminal 202 and the anode of blocking diode 217 is connected to terminal 201. The anodes of diodes 213, 214 are connected together and to the tap of voltage divider 211, 212 and to the low side of the rectifier through a capacitor. Voltage conducted forward through over voltage detecting diode 214 is fed to the gate terminal of the SCR through terminal 202, but is blocked from entering the integrated circuit 40 by blocking diode 217.

When indication triggering diode 213 conducts forward current to the base of transistor 215, transistor 215 will become conducting and allow photodiode 216 to conduct current from the high side of the rectifier to the low side of the rectifier and thus emit light which will provide a visual indication of an over voltage condition. The sensitivity of the over voltage detection (that is, the critical line voltage at which the GFCI will trip) is determined by the voltage divider ratio of resistors 211, 212 and the forward V-I characteristic of over voltage detecting diode 214. Accordingly, the sensitivity of circuit 210 to an over voltage condition can be adjusted by changing the resistance values of the voltage divider resistors 211, 212.

In another embodiment, the direct conductive path 219 is replaced with a Zener Diode 222 where the cathode terminal of the Zener Diode is connected to the tap terminal of the voltage divider network and the anode terminal of the Zener Diode is connected to the anode terminals of diodes 213, 214 and through the capacitor 218 to the ground terminal as shown in FIG. 4. This embodiment allows for an over voltage window detector.

It will be appreciated that with the addition of over voltage protection circuit 210, ground-fault and ground-neutral fault protection in the GFCI is still provided as with circuit 10. When a fault is detected, a signal from triggering pin 1 is fed through terminal 201, blocking diode 217 ( which does not block the current in this scenario) and terminal 202 to the gate of SCR as in the arrangement of FIG. 1. At the same time, over voltage detecting diode 214 blocks the signal from the IC from reaching the voltage divider.

Although the diodes are described above as the over voltage detecting diode, the blocking diode, and the indication triggering diode, it should be noted that these are descriptive terms that are merely intended to aid the reader in understanding the description. No specific properties of these diodes are intended by using these terms. In the embodiment described, these diodes can be of any given type that is suitable for this embodiment described. In addition, circuit 210 may also be integrated directly into the IC. Alternatively, if the GFCI uses a microprocessor, or a microcontroller, circuit 210 can be integrated into the microprocessor as well. Integrating a circuit 210 into an IC, microprocessor, or a microcontroller is well known to those skilled in the art.

While there have been shown and described and pointed out the fundamental novel features of the invention as applied to the preferred embodiments, it will be understood that various omissions and substitutions and changes of the form and details of the method and apparatus illustrated and in the operation may be done by those skilled in the art, without departing from the spirit of the invention.

What is claimed is:

1. An over voltage protection device adapted to be coupled to a ground fault circuit interrupter (GFCI) comprising:
a voltage divider network having a tap adapted to be connected across line terminals of the GFCI; and
an over voltage detecting diode connected between the tap of the voltage divider network and a gate terminal of an SCR to cause the GFCI to trip upon the occurrence of an over voltage condition.

2. The over voltage protection device of claim 1 further comprising:
a blocking diode coupled between a terminal on an integrated circuit of the GFCI adapted to provide a trigger signal and the gate terminal of the SCR to block the signal from the over voltage detecting diode from reaching the integrated circuit.

3. The over voltage protection device of claim 1 wherein:
over voltage sensitivity detection is determined by the voltage at the tap of the voltage divider network and the forward V-I characteristics of the over voltage detecting diode.

4. The over voltage protection device of claim 3 wherein voltage at the tap of the voltage divider is substantially 0.0045V_{O}, where V_{O} is the power supply voltage.

5. The over voltage protection device of claim 1 wherein the voltage divider network comprises a first resistor coupled in series with a second resistor to provide a tap at the junction of said resistors, and said first and second resistors are coupled across the line terminals of the GFCI.

6. The over voltage protection device of claim 5 wherein said first resistor has a value of 200K ohms, more or less, and said second resistor has a value of 910 ohms, more or less.

7. The over voltage protection device of claim 1 further comprising:
a series circuit of an indicator and a transistor coupled across the line terminals of the GFCI; and
an indication triggering diode coupled between the tap of the voltage divider and the transistor to cause the transistor to conduct current and cause the indicator to provide an indication of the occurrence of an over voltage condition.

8. The over voltage protection device of claim 7 wherein the indicator is a photodiode

9. The over voltage protection device of claim 7 further comprising a resistor coupled in series with the indicator to limit the current flow through the indicator.

10. The over voltage protection device of claim 1 further comprising:
a Zener Diode coupled between the tap of the voltage divider network and the over voltage detecting diode.

11. The over voltage protection device of claim 11 wherein the cathode terminal of the Zener Diode is coupled to the tap of the voltage divider network.

12. A method of tripping a GFCI comprising the steps of:
detecting the value of the voltage across the line terminals of the GFCI; and
causing a trip signal to be applied to trip the GFCI upon the occurrence of an over voltage across the line terminals of the GFCI.
